(19) United States
(12) Patent Application Publication
(10) Pub. No.: US 2010/0301730 A1
(43) Pub. Date: Dec. 2, 2010

(54) HIGH INTENSITY DISCHARGE ARC LAMP USING UV-ABSORBANT COATING

(75) Inventors: Kyekyoon Kim, Champaign, IL (US); Ju Gao, Champaign, IL (US); Hyungsoo Choi, Champaign, IL (US); Ravindra P. Singh, Urbana, IL (US)

Correspondence Address: UIUC Docket, 304 Indian Trace Rd, #750, Weston, FL, 33326, US

(73) Assignee: The Board of Trustees of the University of Illinois, Urbana, IL (US)

(21) Appl. No.: 12/601,445

(22) PCT Filed: May 22, 2008
(86) PCT No.: PCT/US08/64518

§ 371 Date: Jun. 16, 2010

Related U.S. Application Data
(60) Provisional application No. 60/939,613, filed on May 22, 2007.

(51) Int. Cl. H01J 61/35; B05D 5/12; B05D 1/04

(52) U.S. Cl. 313/110; 427/58; 427/458

(57) ABSTRACT

A high intensity discharge arc lamp comprises an arc tube, a metal halide in the arc tube, and a coating on the arc tube. The coating comprises a UV absorbent material.

### CROSS-REFERENCE TO RELATED APPLICATION

This application claims the benefit of provisional application No. 60/939,613 entitled “HIGH INTENSITY DISCHARGE ARC LAMP USING UV-ABSORBANT COATING” filed 22 May 2007, attorney docket no. ILL01-103-PRO, the entire contents of which are hereby incorporated by reference, except where inconsistent with the present application.

### BACKGROUND

Discharge lamps, dosed with special radiating materials such as metal halides, are among the most efficient light sources mankind has ever made. Combined with high lumens output and excellent color balance, these light sources are used in general lighting illuminating buildings, streets, large facilities as well as special applications such as projectors and automobiles. Though the lamps have been engineered so that the majority of the radiation is in the visible range, which contributes to the high lumen efficacy, there is a significant portion of UV radiation that has to be filtered out. The filtering can be carried out by the fixture itself or by using an additional optical element; a light source without UV radiation would increase the usage of the light source and reduce the adverse impact of the UV radiation to the fixture materials.

TiO₂ is a common oxide that has widespread applications. Due to its wide band gap at around 3 eV, TiO₂ is effective in absorbing ultraviolet (UV) radiation that enables many UV-blocking applications. TiO₂ also possesses strong photo-catalytic effect; that is when it is irradiated by UV radiation, it produces OH and O radicals on the surface that are potent in breaking down dusty materials and destroying microbiological agents, inspiring self-cleaning and germicidal applications.

Flow-limited field-injection electrostatic spraying (FFESS) is a novel thin-film deposition method wherein field-injection charging using a nano-sharpened tungsten electrode inserted in an insulating nozzle produces electrostatic spray of precursor solutions. These charged nano-drops are subsequently accelerated toward a substrate (room-temperature or heated) for film deposition showing many advantages for the fabrication of thin films: (a) the electrostatic repulsion between the charged nanodrops delivered onto the substrate helps to produce homogeneous coating; (b) the very large specific surface area of the nanodrops makes the film deposition highly receptive to pyrolysis and annealing; (c) no vacuum is required for the deposition; (d) even relatively insulating solutions can be sprayed successfully because of the field-injected charge; (e) since field injection can generate high currents at low applied voltages giving rise to a high and uniform surface-charge density, multiple-jet sprays can be generated in a stable and reproducible manner giving more uniformity to spray distribution.

### SUMMARY

In a first aspect, the present invention is a high intensity discharge arc lamp, comprising an arc tube, a metal halide in the arc tube, and a coating on the arc tube. The coating comprises a UV absorbent material.

In a second aspect, the present invention is a lamp housing, comprising a glass or quartz housing, and a coating on the housing. The coating comprises a UV absorbent material.

In a third aspect, the present invention is a method of making a lamp housing, comprising coating a glass or quartz housing with a UV absorbent material.

In a fourth aspect, the present invention is a method of making a high intensity discharge arc lamp, comprising coating a glass or quartz housing with a UV absorbent material; and forming a high intensity discharge arc lamp from the housing.

In a fifth aspect, the present invention is a method of reducing the UV light output of a high intensity discharge arc lamp, comprising coating the lamp housing with a UV absorbent coating.

### BRIEF DESCRIPTION OF THE DRAWINGS

FIG. 1 illustrates a schematic of an experimental setup for coating on a quartz HID arc tube by rotating the tube between a positive and a negative FFESS nozzle spraying towards each other;

FIG. 2A represents an SEM micrograph of a TiO₂ coating;

FIG. 2B represents an AFM micrograph of a TiO₂ coating;

FIG. 3A depicts an X-ray diffraction plot of the titania coating on silicon indicating a presence of titania in anatase and rutile phases;

FIG. 3B depicts an absorption spectrum of TiO₂ on quartz;

FIG. 4 depicts a spectrum of 68 W DC MHL before (a) and after (b) application of a TiO₂ coating; and

FIG. 5 depicts a thermal imaging of (a) uncoated and (b) TiO₂ coated lamps in operation.

FIG. 6 is a schematic of a high-intensity discharge lamp 10, illustrating the lamp housing 14, the electrodes 12, reagents for the plasma 16, and during operation, the arc 18. In the present invention, a UV-absorbent coating 20 is also present on the housing.

### DETAILED DESCRIPTION

We thus explore depositing a thin layer of TiO₂ directly on the plasma envelops known as the arc tubes for two main purposes. First, we wanted to filter out the UV radiation so that the lamps can be used directly without worrying about the harm that the UV radiation can cause. Second, we expected the photo-catalytic effect under the same UV radiation can self-clean the lamp and perhaps even add to the environment friendliness of the lamp. To enhance the latter effect, we devised to apply a nano-structured TiO₂ coating to increase the surface area. However, the complex structure of the lamp requires the coating to be conformal to achieve a uniform coating. We also had the practical need in mind that the coating may need to be applied in an open air, room temperature environment to handle the large scale and high yield desirable in actual production. Flow-limited field-injection electrostatic spraying, as mentioned below is well suited to meet all these demands.

The invention improves the quality of light output from HID (high intensity discharge) arc lamps.

The present invention produces a thin-film coating of UV-absorbent materials, with controlled surface morphology, on the external surface of a HID arc lamp to achieve enhanced performance. The thin films of the desired materials are deposited using the FFESS technique. Preferably, the UV-absorbent material contains a metal oxide, more preferably titanium oxide.

The present invention includes improving efficiency of high intensity discharge (HID) arc lamps with thin coatings of UV absorbent materials, and deposition using flow-limited field-injection electrostatic spraying (FFESS) to facilitate deposition of such coatings of highest quality at relatively low costs without use of clean rooms or vacuum chambers.

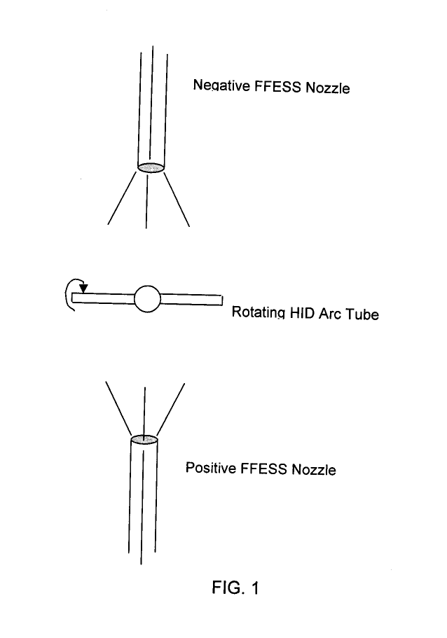

Approximately 300-500 nm thick coatings of TiO₂ precursor were deposited on the arc tubes by rotating the tube between a positive FFESS nozzle and a negative FFESS nozzle spraying towards each other (FIG. 1). Tube rotation helps expose all regions of tube surface to the positive and negative spray particles evenly, eliminating any charge build up on any portions of tube. Thus, even though the arc tube is non-conducting and non-grounded, it can receive the charged nanodroplets in a continuous manner for long durations.

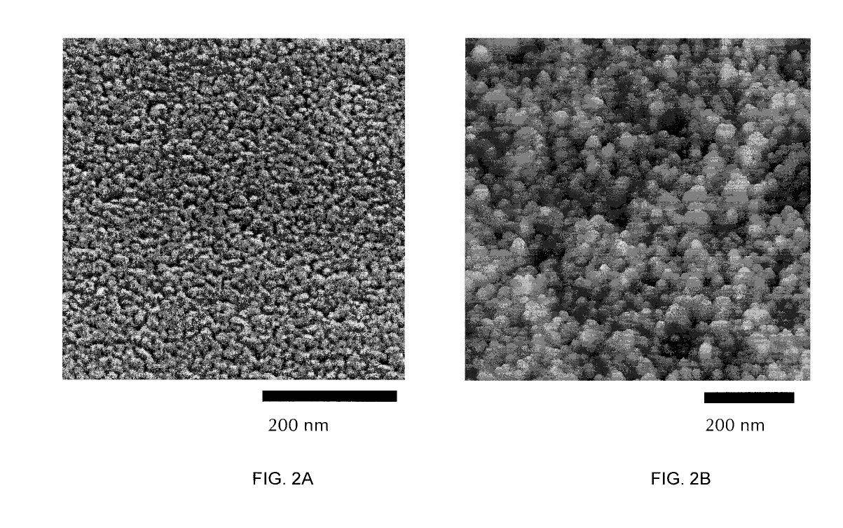

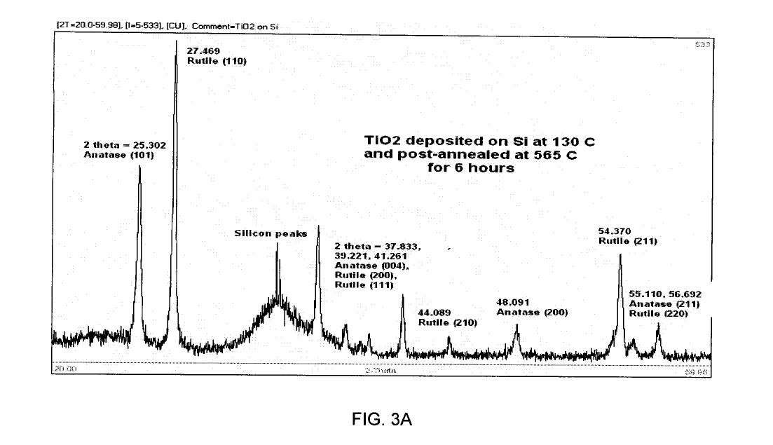

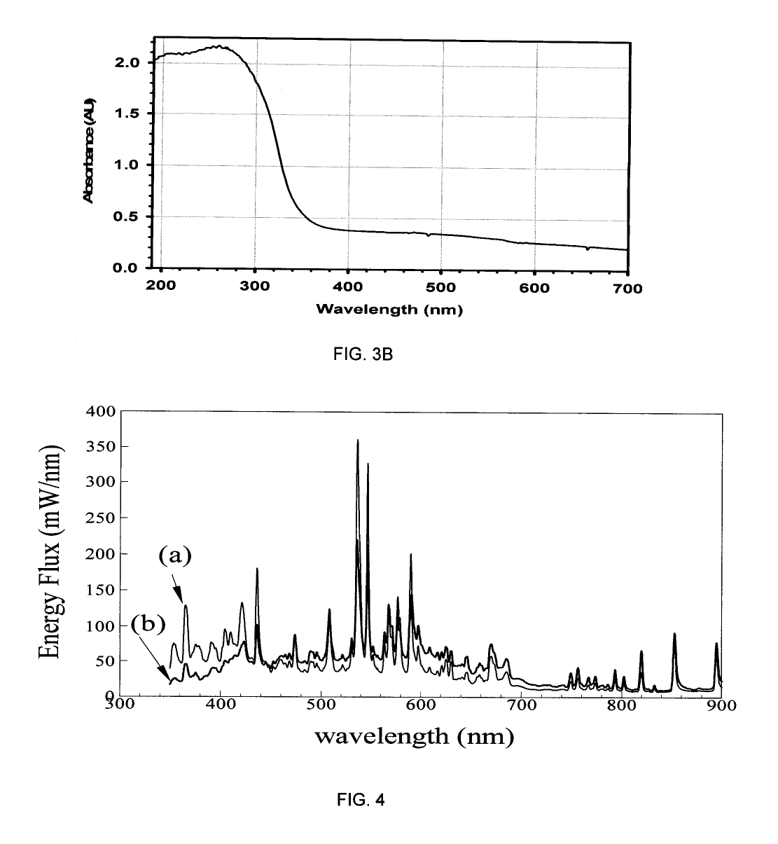

The TiO₂ precursor coatings are converted into TiO₂ coatings when the lamp operates and the surface temperature increases causing annealing of the precursor. Coatings deposited on quartz substrates (the arc tube envelope may be quartz or glass) and annealed in the same manner indicate the presence of a smooth thin film on the surface as shown by SEM and AFM data in FIG. 2. XRD data for the same coating prepared on a silicon substrate is shown in FIG. 3, indicating the presence of both anatase and rutile phases of TiO₂. The optical absorption measurements with the quartz substrate show the absorption edge at about 320 nm (FIG. 3).

The metal oxide precursor can be selected from those commonly known in the art, for instance precursors used in the production of ceramics, spin coating and chemical vapor deposition. Useful metal oxide precursors include soluble compounds of the metals. Examples are organometallic metal oxide precursors such as alkoxides, alcoholates, acetylacetates and carboxylates; water-soluble metal oxide precursors such as acetates, halides and nitrates are also useful. Mixtures thereof may also be used.

Examples of metal oxide precursors are metal oxide precursors of metals such as Ti, Zn, Sn, Zr, Ni, Pb, Sr, Nb, Ta, Al, Sn, Fe, Ce, Mg, Y, Ba, Al and Hf. Mixtures of metal oxide precursors are also useful, and may be used for the addition of dopants or minority phases. Other metal complexes, such as metal acetates and other metal carboxylates, and metal acetylacetonates may also be used as metal oxide precursors. Specific example metal oxide precursors include: Ti(i-Pro)₂(acac)₂, Ti(t-BuO)₄, Ti(i-Pro)₄, Si(OEt)₄, Zr(COOCH₃)₄, Mg(COOCH₃)₂, Y(C₅H₇O₂)₃, Pt(C₅H₇O₂)₂, SrCO₃, (NH₄)ₓ(WO₄)_{y}, Cu(C₅H₇O₂)₂, Nd(C₅H₇O₂)₃, Ni(C₅H₇O₂)₂, Co(C₅H₇O₂)₂, V(C₅H₇O₂)₃, Pd(C₅H₇O₂)₂, MgSO₄, AgNO₃, AlNO₃, ZnCl₂, ZrOCl₂, ZrO(OH)Cl and MgCl₂.

The coatings include UV-absorbent films on the exterior surface of the HID arc lamps. FFESS-based coating of thin films of materials has been previously described as follows:

K. Kim & C. K. Ryu, “Method and apparatus for producing nanodrops and nanoparticles and thin films therefrom,” U.S. Pat. No. 5,344,676, Sep. 6, 1994.

K. Kim & Q. Feng “Method and apparatus for producing thin film and nano particle deposits,” U.S. Pat. No. 5,948,483, Sep. 7, 1999.

K. Kim & Q. Feng “Method of producing thin film and nano particle deposits using charges of alternating polarity,” U.S. Pat. No. 6,060,128, May 9, 2000.

Kyekyoon Kim and Ravindra Pratap Singh, “Electrohydrodynamic Spraying System,” Patent Case No. 10322/67, OTM File No.: TF03108; Filed Nov. 22, 2004, published as Patent Application Publication, Pub. No. US 2006/0110544 (May 25, 2006).

C. K. Ryu and K. Kim, “Fabrication of ZnO thin films using charged liquid cluster beam technique”, Applied Physics Letters, 67:22, 3337-3339, 1995.

K. Kim and C. K. Ryu, “Generation of charged liquid cluster beam of liquid-mix precursors and application to nanostructured materials,” Nanostructured Materials, vol. 4, no. 5, pp. 597-602, 1994.

M. Cich, K. Kim, H. Choi, and S. T. Hwang, Deposition of (Zn,Mn)₂SiO₄ for plasma display panels using charged liquid cluster beam, Applied Physics Letters, 73:15, 2116, 1998.

S. H. Rhee, Y. Yang, H. S. Choi, J. M. Myoung, and K. Kim, Deposition of highly [100]-oriented MgO films at low temperature by charged liquid cluster beam, Thin Solid Films, 396, 23-28, 2001.

Hyungsoo Choi, Sungho Park, Yi Yang, HoChul Kang, Kyekyoon (Kevin) Kim, M. Y. Sung, and Ho G. Jang, Low-temperature fabrication of high-quality (Ba, Sr)TiO₃ films using charged liquid cluster beam method, J. Materials Research, 17:8, 1888-1891, 2002.

H. Kang, S. Park, H. Choi, K. Kim, M. Sung, “Low-Temperature Growth of Highly Crystalline (Ba, Sr)TiO₃ Films by Charged Liquid Cluster Beam Method”, Electrochem. Solid-State Lett., 7, F77-F80, 2004.

H. Kang, S. Park, H. Choi, K. Kim, M. Sung, “SrTiO₃ Thin Films Deposited by Charged Liquid Cluster Beam Technique in Combination with Sol-Gel Processing”, Electrochem. Solid-State Lett., 7, F70-F72, 2004.

The photometry measurements show that the UV portion of the spectrum is blocked by the film effectively. However, the results also show, more interestingly, that the visible portion of the spectrum is enhanced in the green to red region. FIG. 4 shows the spectra before and after the coating is applied. The result has been repeated in a 6 lamp group and shows the tendency consistently. Quantitatively, the following results are obtained (table 1): (1) the lumens output is increased by as high as 15%; the color rendering index (CRI) is improved from an average of 71 to 80; and (3) the color temperature drops from 5957K to 5092K. These are all positive features that improve the lamp.

TABLE 1
Average photometric results for 68 W DC metal
halide lamps before and after TiO₂ coatings.

| | Lumens | Volts (V) | Current (A) | CRI | CCT (K) |
|---|---|---|---|---|---|
| Before coating | 5541 | 96 | 0.71 | 71 | 5957 |
| After coating | 5774 | 106.8 | 0.64 | 80 | 5092 |

A possible explanation of this unexpected benefit can be given as follows. The coating absorbs the UV radiation. It thus heats up the arc tube wall, perhaps uniformly. It then helps evaporate more metal salts that stick to cold spots. In other words, the UV energy is recycled to heat up the salts so that there are more radiators in the plasma. Another possible mechanism may be that the film reflects a good portion of the IR because of the large refractive index difference between the TiO₂ and quartz, even though it is just one layer of coating.

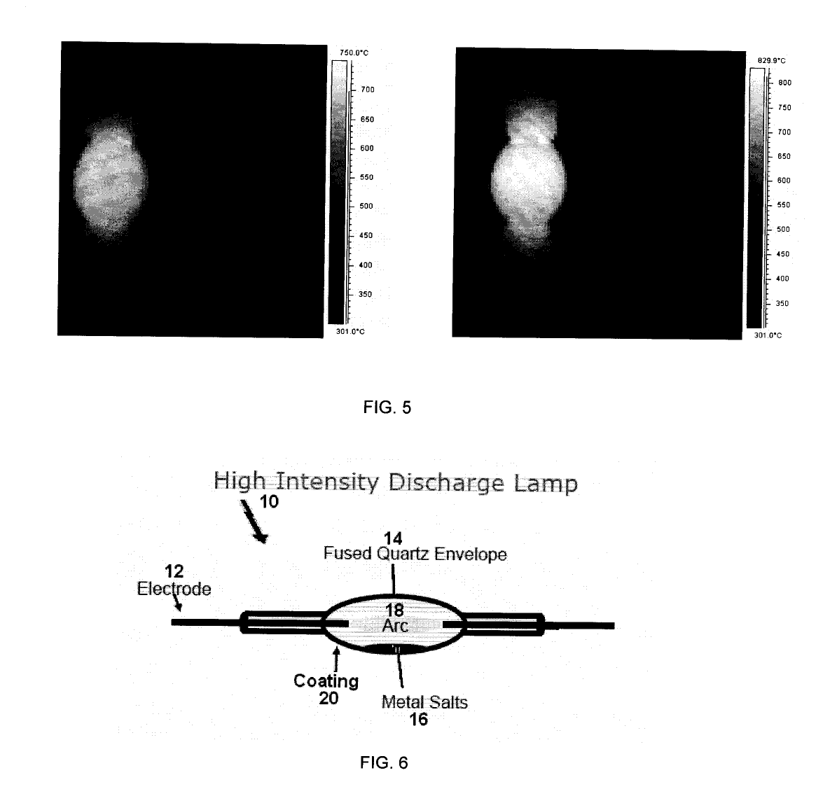

We have direct evidence of wall temperature increase by using a thermal camera to measure the surface temperature. The measurement is straightforward on the arc tubes before and after the coating, as shown in FIG. 5.

As a result of the increased wall temperature and more salts being released into the plasma, we have observed the voltage to sustain the plasma, often referred to as the lamp voltage, increased due to the paschen curve. This means that by applying the same power, the current drops. Then the ohmic loss on the electrodes is reduced and more power is consumed by the plasma. In the end more power is used to produce light after we form the coating to change the plasma boundary conditions. Tests show that the coatings survive for over 2000 hours.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A high intensity discharge arc lamp, comprising:
an arc tube,
a metal halide, in the arc tube, and
a coating on the arc tube,
wherein the coating comprises a UV absorbent material.

35. The high intensity discharge arc lamp of claim 34, wherein the UV absorbent material comprises one of a metal oxide and a titanium oxide.

36. The high intensity discharge arc lamp of claim 34, wherein the coating has a thickness ranging from 50 to 2000 nm.

37. A lamp housing, comprising:
a glass or quartz housing, and
a coating on the housing,
wherein the coating comprises a UV absorbent material.

38. The lamp housing of any of claim 37, wherein the housing is a tube.

39. The lamp housing of any of claim 37, wherein the UV absorbent material comprises one of a metal oxide and a titanium oxide.

40. The lamp housing of claim 37, wherein the coating has a thickness ranging from 50 to 2000 nm.

41. A method of making a lamp housing, comprising coating a glass or quartz housing with a UV absorbent material.

42. The method of claim 41, wherein the coating is formed by flow-limited field-injection electrostatic spraying.

43. The method of claim 41, wherein the housing is a tube.

44. The method of claim 41, wherein the UV absorbent material comprises one of a metal oxide, and a titanium oxide.

45. The method of claim 41, wherein the coating has a thickness ranging from 50 to 2000 nm.

46. A method of making a high intensity discharge arc lamp, comprising:
coating a glass or quartz housing with a UV absorbent material; and
forming a high intensity discharge arc lamp from the housing.

47. The method of claim 46, wherein the coating is formed by flow-limited field-injection electrostatic spraying.

48. The method of claim 46, wherein the housing is a tube.

49. The method of claim 46, wherein the UV absorbent material comprises one of a metal oxide, and a titanium oxide.

50. The method of claim 46, wherein the coating has a thickness ranging from 50 to 2000 nm.

51. A method of reducing the UV light output of a high intensity discharge arc lamp, comprising coating the lamp housing with a UV absorbent coating.

52. The method of claim 51, wherein the lumens output of the lamp is increased, as compared to an otherwise identical lamp without the UV absorbent coating.

53. The method of claim 51, wherein the color rendering index of the lamp is improved, as compared to an otherwise identical lamp without the UV absorbent coating.

54. The method of claim 51, wherein the color temperature of the lamp is reduced, as compared to an otherwise identical lamp without the UV absorbent coating.
